(19) United States
(12) Patent Application Publication
(10) Pub. No.: US 2002/0081060 A1
(43) Pub. Date: Jun. 27, 2002

(54) MEMS based over-the-air optical data transmission system

(76) Inventors: Shlomo Margalit, Winneka, CA (US); Herzel Laor, Boulder, CO (US)

Correspondence Address: Scott B. Dunbar, 3334 Crossland St., Thousand Oaks, CA, 91362, US

(21) Appl. No.: 09/878,015

(22) Filed: Jun. 8, 2001

Related U.S. Application Data
(63) Continuation of application No. 60/210,613, filed on Jun. 9, 2000.

(51) Int. Cl. G02B 6/35; H04B 10/00; H04B 10/12

(52) U.S. Cl. 385/18; 359/154; 359/173

(57) ABSTRACT

Building-to-building over the air transmission of optical data is a growing area of data communications. The fast growing use of bandwidth mandates the use of over the air transmission equipment capable of similar performance as the performance of fiber optic transmission, for distances of 3-10 Km. Transparent transmission is important, to enable seamless growth from low data-rate to Gbps rates, and then to Dense Wavelength Division Multiplexed (DWDM) transmission of several wavelengths. The only way to achieve the required performance is with narrow, directable beams. The present invention uses Micro-Electro-Mechanical-Systems (MEMS) mirror based, over the air optical data transmission system. A narrow optical beam is used and a MEMS mirror fine-tunes the aiming of the beam to track building movement, vibrations etc.

### CROSS REFERENCE TO RELATED APPLICATIONS

This application claims the benefit of U.S. Provisional Application No. 60/210,613, filed Jun. 9, 2000, entitled MEMS Based Over-The-Air Optical Data Transmission System.

### FIELD OF THE INVENTION

The invention relates to a method of improving the accuracy of optical data transmission systems.

### BACKGROUND OF THE INVENTION

Greater data inter-connectivity, required for business, requires greater capacity for carrying that data between local business locations. Some businesses are spread over large campuses, while others expand beyond their buildings requiring some employees to be located in neighboring facilities. There is a need for inter-building data communications. In many cases, local phone companies can provide inter-building communication at a high price. In other cases, local phone companies lack the capacity to provide the required service. Most companies would prefer to invest in communication equipment, rather than continue paying a local phone company for data communications service. Where line of sight communications is possible, microwave or optical communications is the answer. Microwave communication is highly regulated by the Federal Communications Commission and provides less bandwidth, than optical data transmission.

Optical interconnect with light beams between buildings suffers from a difficulty associated with the movement of the buildings. The movements include waving in the wind, environmental vibrations, land shift, earthquakes, etc. Common over-the-air optical transmission equipment either uses narrow beam laser transmitters with tracking mechanisms or uses LED based wide beam transmitters with fixed aiming.

U.S. Pat. No. 4,662,004 Fredriksen et al. Fredriksen describes an optical communication link that includes a separate laser (in addition to the data transmission laser), which returns information about the level of the received sin to the transmitter. This separate laser is adjusted to emit power proportional to the received beam power.

U.S. Pat. No. 4,832,402 Brooks. Brooks describes a fast scanning mirror used to time-multiplex a light beam into several steering mirrors, each of the steering mirrors aim the beam into one or a group of targets clustered together. The steering mirrors are slow due to the large angle required. Brooks also describes the use of “beacon transmitters” to aid in target tracking.

U.S. Pat. No. 5,282,073 Defour et al. Defour shows optical communications system with two galvanometer mirrors for beam steering, and a complex wide-angle lens to increase the angular scanning to a half-sphere. Defour also describes target designation step, iterative step of bilateral acquisition and a third step of exchanging data.

U.S. Pat. No. 5,390,040 Mayeux. Mayeux describes the use of one steer-able mirror at the expanded beam location, for aiming both the transmit beam and receive beam. Part of the surface of the mirror is used for transmission, and another part for reception. Mayeux calls these parts of the mirror “field of views”, in contrast to common terminology.

U.S. Pat. No. 5,448,391 Iriama et al. Iriama describes the use of optical Position Detector sensor (common art) to track the beam direction. A pair of mirrors is used for slow, large angle direction control and a fast lens is moved for fast corrections.

U.S. Pat. No. 5,646,761 Medved et al. Medved describes here an optical communications between stationary location like an airport gate and a movable object, like an airplane parked at the gate. The optical units on the gate and the airplane are searching for each other and stop this search when aligned.

U.S. Pat. No. 5,710,652 Bloom et al. Bloom describes optical transmission equipment to interconnect low Earth orbit satellites. The whole transmitter and receiver unit is mounted on gimbals. Two lasers are used, one for tracking and one for data. A CCD optical detector detects the target location for tracking servo control.

U.S. Pat. No. 5,768,923 Doucet et al. Doucet discloses the distribution of Television signals from one source to many receivers. The transmitter uses an X-Y beam deflector made of two galvanometer driven mirrors. This assembly is used to direct the beam into a specific receiver at a selected home.

U.S. Pat. No. 5,818,619 Medved et al. Medved describes here a communications network with airlinks. A converter unit is converting the physical data transmission in the network to electricity, and drives an air-link transmitter. Similarly, the received beam is converted to electricity after reception. Medved also describes an optical switch to have one air-link serving plurality of networks between the same two locations.

EP 962796A2 Application Laor et al. This application describes MEMS mirror construction.

### SUMMARY OF THE INVENTION

MEMS is a well known technology that is used to manufacture small mechanical systems using common Silicon foundry processes. We describe here the use of narrow field of view transmission with a MEMS mirror being used to fine tune the beam direction. Since the MEMS mirror is rather small, 1-3 millimeters in diameter, it is impossible to use it to aim the expanded beam. Instead, the MEMS mirror is installed near the light source, where the beam is small in diameter. This positioning enables only small angular deflection of the beam. The transmission equipment will be aimed coarsely manually or with motors, and the MEMS mirror will do fine aiming with fast response. With course motorized aiming, the motors may be operated to search and find the other side of the communication link. After the MEMS mirror begins aiming the beam, the motors could be adjusted slowly to hold the aim such that the MEMS mirror average angular deviation is around zero. This will maximize the correction capability of the MEMS mirror.

Note: we will use here “light” for all electromagnetic waves from the ultra-violate to infrared, and not only for the visible spectrum. This is a common use of the term. The common transmission wavelength is with light in the near infrared between 600 and 1600 nano-meters.

Another feature of the invention is the use of optical fiber to carry light from the light source in the data equipment to the optical beam transmitter on the roof or in a window. Another optical fiber carries the light from the optical beam receiver on the roof or in a window to the detector in the data equipment. This facilitates the changing of data equipment, changing data rates, changing protocols, etc. without the need to replace the optical beam transmitter or beam receiver. The system may be upgraded to carry light in more than one wavelength using the same optical beam transmitter and receiver. For long transmission lengths, an optical fiber amplifier could be installed between the light source and the optical beam transmitter, or between the optical beam receiver and the detector, or both locations. For systems located in areas with common fog problems, such amplifiers could be set to kick-in when transmission is fading.

Yet another feature is the use of two fast optical fiber 1×N switches to time-share the use of a network between several users. One network port will connect to the switches, with two fibers, transmit and receive. On the other side of the switches, each pair of fibers will be connected to a pair of an optical transmitter and an optical receiver, aimed at one network user. This enables the system to begin serving high data rate network interconnect to customers in a time-shared fashion, and adjust the percentage of time used according to the needs of each customer. When the need arises, a dedicated network port could be used to direct-connect a customer for a fill connection. The structure of the system, having fully transparent optical transmitters and receivers, allows for seamless transfer to the use of dedicated fibers between the two locations when such fibers are installed.

A construction is described where the beam transmitter and the beam receiver share the use of one MEMS mirror. Servo control of the MEMS mirror angular position may be achieved with separate servo LED source and servo optical position detector. Close loop servo control is critical to the correct operation of the transmission system.

### BRIEF DESCRIPTION OF THE DRAWINGS

Preferred embodiments demonstrating the various objectives and features of the invention will now be described in conjunction with the following drawings:

FIG. 1 depicts the beam transmitter or beam receiver unit.

FIG. 2 depicts image movement with movement of the MEMS mirror.

FIG. 3 depicts a MEMS mirror and MEMS package.

FIG. 4 depicts an alternative embodiment of the beam transmitter or beam receiver.

FIG. 5 depicts a MEMS mirror course aiming mechanism.

FIG. 6 depicts an alternate mirror course aiming mechanism.

FIG. 7 depicts a network system utilizing the beam transmitter and beam receiver of the present invention.

FIG. 8 depicts a network system utilizing optical amplifiers with the beam transmitter and beam receiver of the present invention.

FIG. 9 depicts a network system utilizing the beam transmitter and beam receiver of the present invention to service multiple sub-networks.

FIG. 10 depicts an alternate embodiment of the present invention wherein a single MEMS mirror is used for both transmit and receive beams.

FIG. 11 depicts an alternate embodiment of the present invention wherein a single MEMS mirror is used for both transmit and receive beams and both beams are substantially collimated.

FIG. 12 depicts a servo control system using an LED to aim the data beam.

FIG. 13 depicts the servo control system using a MEMS mirror to aim the servo control beam.

FIG. 14 depicts a housing containing the beam transmitter and receiver.

FIG. 15 depicts a complete beam transmitter and receiver.

### DETAILED DESCRIPTION OF THE PREFERRED EMBODIMENTS OF THE INVENTION

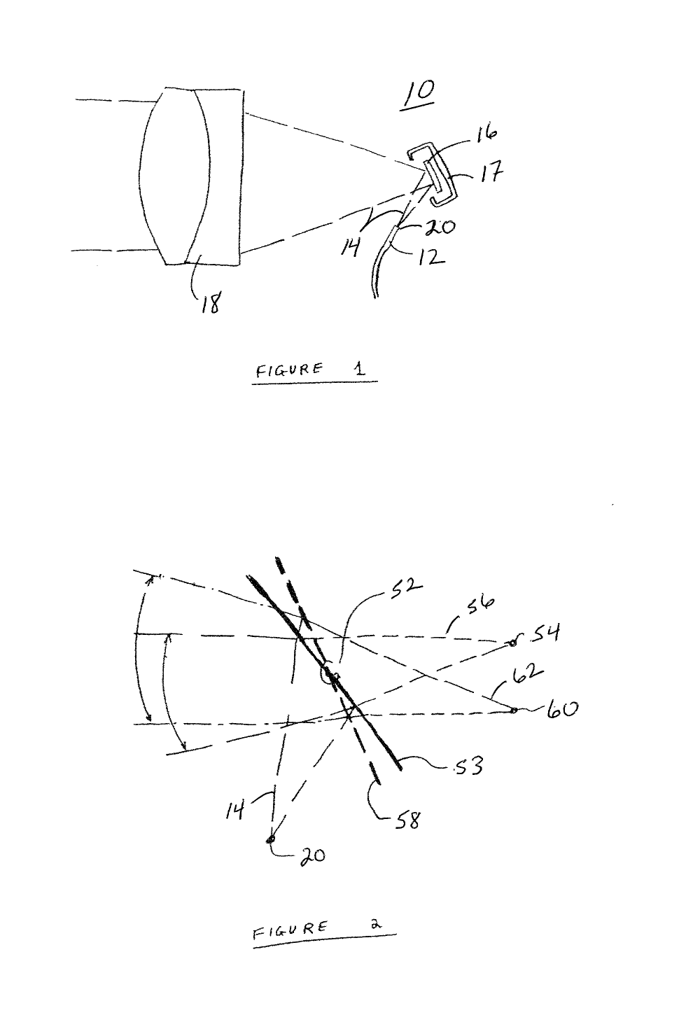

FIG. 1 shows the construction of a beam transmitter or beam receiver unit 10. In a beam transmitter 10, the light that propagates in the optical fiber 12 is exiting the fiber end in a cone of light 14. The optical fiber 12 is a common single mode telecommunications fiber, with core diameter of approximately 10 microns and cladding diameter of 125 microns. The cone of light 14 hits a MEMS mirror 16 and is deflected towards a lens 18, which collimates the beam for transmission. The collimation may not be exact, as larger or smaller beam angles may be required. The MEMS mirror 16 is supported by a mirror package 17, and may be rotated in two degrees of freedom over two perpendicular axises (not shown) which are parallel to the mirror surface. The image of the optical fiber end 20 is thus moved in space. By moving the image of the optical fiber 12, the beam that emerges from the lens changes direction.

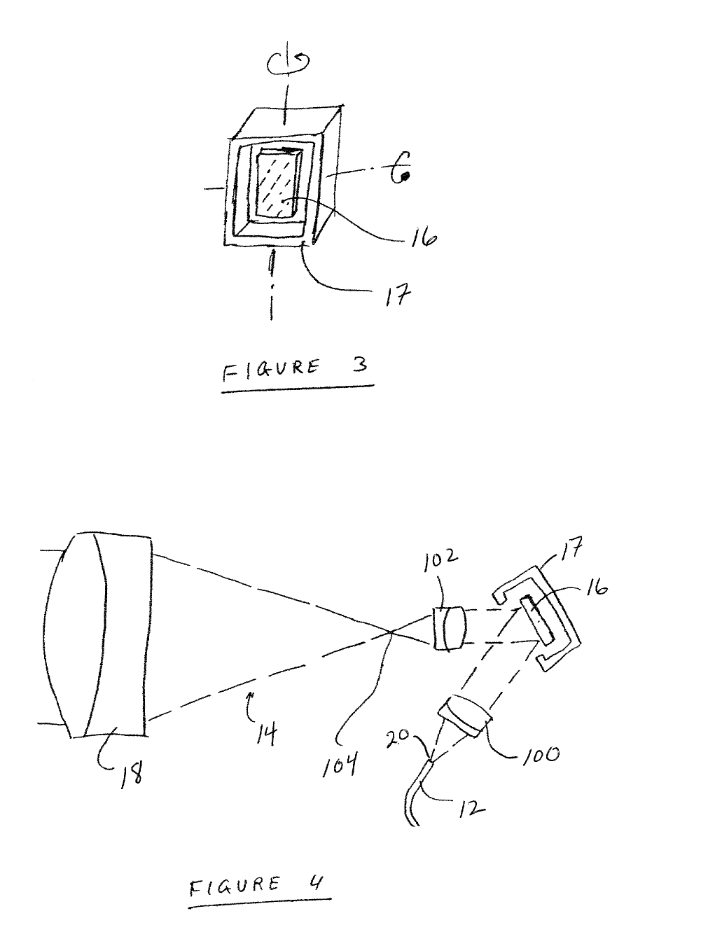

FIG. 2 is a schematic drawing showing the movement of the image of the optical fiber end 20. The light cone 14 emerges from the fiber core at the fiber end 20. The MEMS mirror 16 reflects the light cone 14. The MEMS mirror 16 is rotate-able around the axis 52 shown. The second axis is not shown for clarity. When the MEMS mirror 16 is in position A 53, the MEMS mirror 16 creates an image A 54, and the light exits in cone A 56. When the MEMS mirror 16 is in position B 58, the MEMS mirror 16 creates an image B 60, and the light exits in cone B 62. Since image A 54 and B 60 are in different positions, the lens 18 will collimate light exiting from these images in different directions. The two exiting cones 56 and 62 have some beam wander on the lens, requiring a somewhat larger lens diameter.

In FIG. 3, the MEMS mirror 16 is drawn showing only the MEMS mirror 16 and mirror package 17. The mirror package 17 is a mechanical structure that holds and protects the MEMS mirror 16. The mirror package 17 may have a window that enables hermetic sealing, not shown here for clarity. The MEMS mirror 16 can be controlled to rotate in the horizontal and vertical axis. A detailed description of the type of MEMS mirrors useful for this application may be seen in “Optical Switch Demos in Cross-Connect” by David Krozier and Alan Richards, Electronic Engineering Times, May 31, 1999, p. 80 and in EP 962796A2. The MEMS mirror dimensions are reported to be 3 mm×4 mm. This size is larger then any previously reported MEMS mirror and is quite useful for the construction of the beam transmitter unit. A smaller MEMS mirror will require the fiber to be very near to the mirror, possibly obstructing part of the beam. Also, a small mirror will create only small deviation of the position of the image of the fiber and achieve small active angle of aiming.

FIG. 4 shows a different optical design of the beam transmitter 10. An “on-axis” lens 100 collimates the beam emerging from the fiber 12. The collimated beam is reflected by the MEMS mirror 16 into an “eyepiece” lens 102. The eyepiece lens focuses the beam into a real image spot 104 at or near the focal plane of the lens 18. The lens 18 creates a collimated or nearly collimated beam for transmission. By rotating the MEMS mirror 16, the location of the real image 104 can be adjusted, thereby adjusting the direction of the transmitted beam.

It is a common knowledge that for any path taken by a beam of light, the reverse is also a possible path for another beam. Therefor, FIGS. 1-4, which were described above as beam transmitters 10, could be used to explain similar designed beam receivers. A light beam arrives at the lens 18 and being focused and directed to the fiber end 20 by the MEMS mirror 16. The direction from where the fiber will accept light is controlled by the MEMS mirror 16. The fiber 12 in the beam receiver could be identical to the fiber 12 in the beam transmitter, but it may also be a common Multi Mode fiber, with core diameter of 50 or 62.5 microns and clad diameter of 125 microns. Larger core diameter will allow relaxed aiming accuracy, but will limit the data rate if the fiber is lone, due to modal dispersion.

A pair of units, a beam transmitter and a beam receiver, together creates an optical link. The distance between beam transmitter and beam receiver could be several kilometers. For two-way communications, light can be made to propagate in the fibers in both directions simultaneously. Alternatively, Two pairs of units can be used to create a full duplex link.

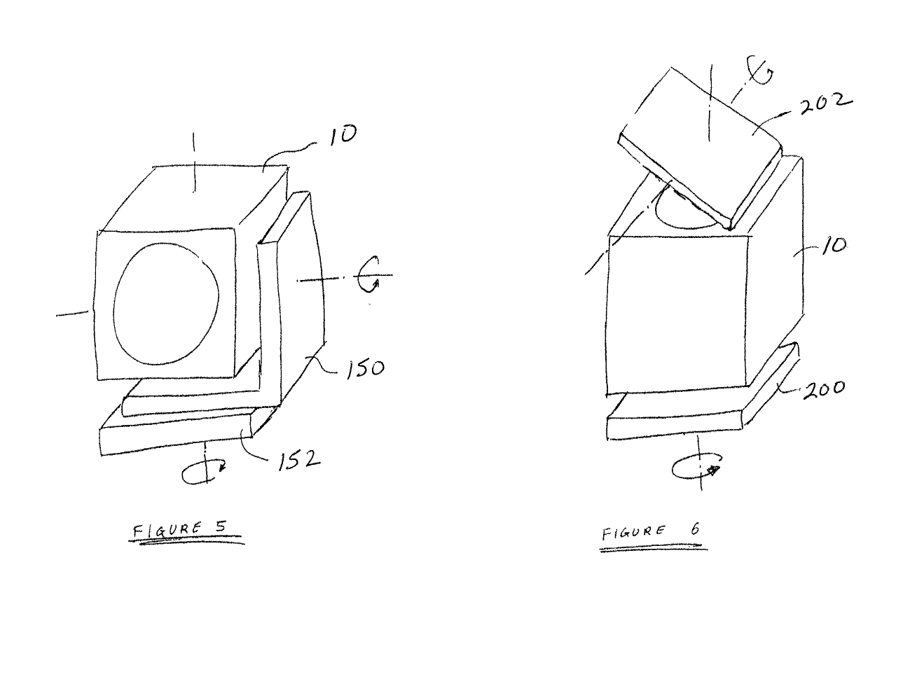

The beam steering by the MEMS mirror is limited in angle. Only few degrees of angular deviation are possible. In some designs, only a fraction of a degree of adjustment is possible. Therefore, a mechanism for course aiming is required, that is capable of aiming in 360 degrees in azimuth and approximately+/−45 degrees in elevation. FIG. 5 is an example of such mechanism. The beam transmitter (or receiver) 10 is mounted onto a mount 150, with a motor that controls the horizontal axis of rotation of the beam transmitter/receiver 10. This motor enables the movement of the beam in elevation. The exact design of the motor and movement mechanism is not shown since it is a common art. The mount is attached to a base 152 with similar drive, which enables rotation around the vertical axis, for adjusting the beam direction in azimuth. The motors are capable of aiming the beam generally to the target, but are neither fast nor accurate enough to track the building movements.

FIG. 6 is a different azimuth—elevation structure. The beam transmitter or receiver is mounted on a base facing up. A large folding mirror 202 directs the beam in a general horizontal direction. The beam transmitter (receiver) 10 and the folding mirror 202 rotate around the vertical axis for azimuth control. It is possible that only the folding mirror 202 will rotate to achieve azimuth control. The mirror aims the beam in elevation by rotating around a horizontal axis. Again, the motor drive is not shown since it is common art.

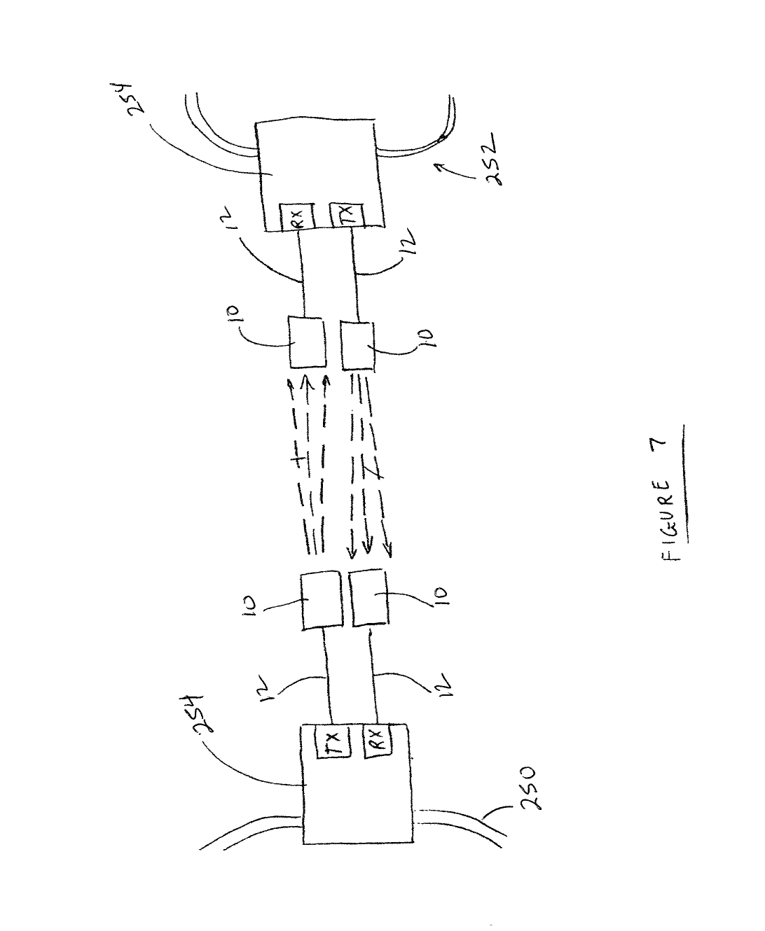

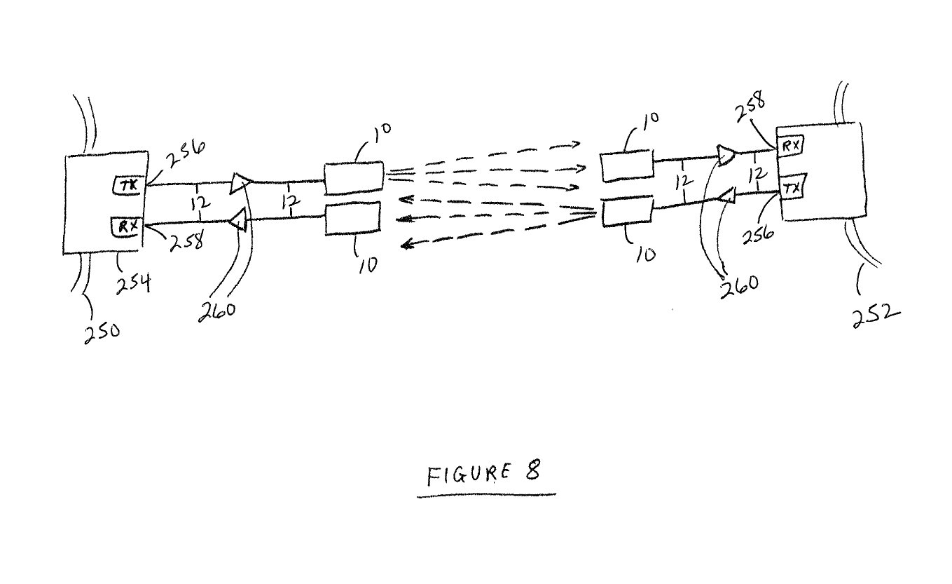

FIG. 7 shows a network system using the beam transmitters and receivers 10 described above. A main network 250 needs to interconnect with a sub network 252. The main network 250 and the sub network 252 are located in different buildings with free line-of-sight between them. Also possible is interconnect between different floors of the same building by sending the beams vertically. A network element 254 is attached to the main network, such as a switch, router and the like. A port in the network element 254 is connected to the beam transmitter and receiver 10 with a pair of fibers 12. A laser or LED transmitter 256 and a PIN or avalanche photo diode detector 258 at the network element perform the light generation and detection respectively, commonly marked TX and RX. The beam transmitter and receiver 10 are mounted on the roof or in a window, aimed at the beam transmitter and receiver 10 which is connected to the sub network 252 with fibers 12. When the beam units are correctly aimed at each other, light from the TX unit 256 at each network element 254 is passing via the fiber 12 to the beam transmitter 10, over the air to the beam receiver 10, and to the RX unit 258 at the other network element 254. Hence, full duplex communication is established.

Since the network element 254 sees standard fibers attachments, it is very simple to connect direct point-to-point optical fibers when available, replacing the over-the-air link. This feature allows for seamless growth of the network.

Optical transmission from the TX unit 256 to the RX unit 258 will suffer losses, due to loss in the fibers, optical aberrations and diffraction in the beam transmitter and receiver 10, the receiver aperture being smaller in diameter than the beam generated by the beam transmitter, inaccuracies in the aiming servo mechanisms for both transmitter and receiver, optical absorption and scattering in the atmosphere etc. In common 2.5 Gbps transmission equipment such loss is allowed to reach 20-30 dB, i.e. only 1/100 to 1/1000 of the light transmitted by the laser should arrive at the detector to achieve low error rate transmission. If the link loss is excessive, fiber amplifiers 260 could be inserted in the link as shown in FIG. 8. The optical fiber amplifiers that are commonly used are Erbium Doped Fiber Amplifiers (EDFA). An amplifier may be inserted into the link after the laser to boost the transmitter power, or before the receiver to increase the received optical power, or in both locations. If the high loss is a phenomenon related only to fog conditions, the amplifiers 260 may be inserted actively when the bit error rate deteriorates.

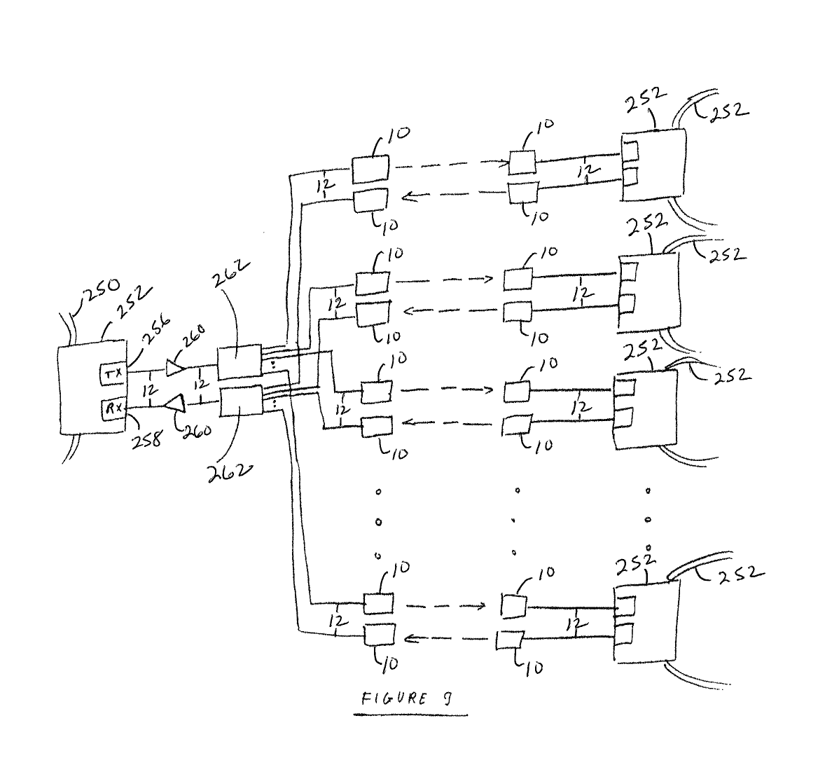

FIG. 9 shows a system where several sub networks are served by one main network. 1×N fiber optics switch 262 is attached to the TX unit 256 in the main network 250. The fiber optic switch 262 is serving light to one of the beam transmitters 10 at a time. A second fiber optic switch 262 is connected to the RX unit 258. Each sub network 252 operates for a short time, and then is disconnected for a longer time. For example, the switching time may be 5 mS and each sub network 252 could be served for 100 mS at a time. If there are 5 sub-networks 252, there will be a gap of 425 mS between connections for any specific sub-network 252. Some messages may be delayed, but this may be tolerated. If the link loss is different to different sub-networks, the gain of the optical amplifier may be adjusted to each sub network differently. Fast AGC is required on all the RX units 258. This construction enables the installation of standard transmission equipment, for example Gigabit Ethernet, in all the network elements, even when the communications needs are lower, and adjusting the main network connect time to each sub-network according to its needs. An advantage is the use of only two optical amplifiers, which are expensive. Another advantage is that the connectivity to each sub-network 252 may be adjusted without the need for a physical equipment change, and remotely. The user of the sub-network 252 may be charged for network services according to the average data rate he uses. Only when a sub-network 252 needs fill connectivity at the main network 250 data rate, then this sub-network 252 could be assigned a port in the main network and direct connection instead via the fiber switches.

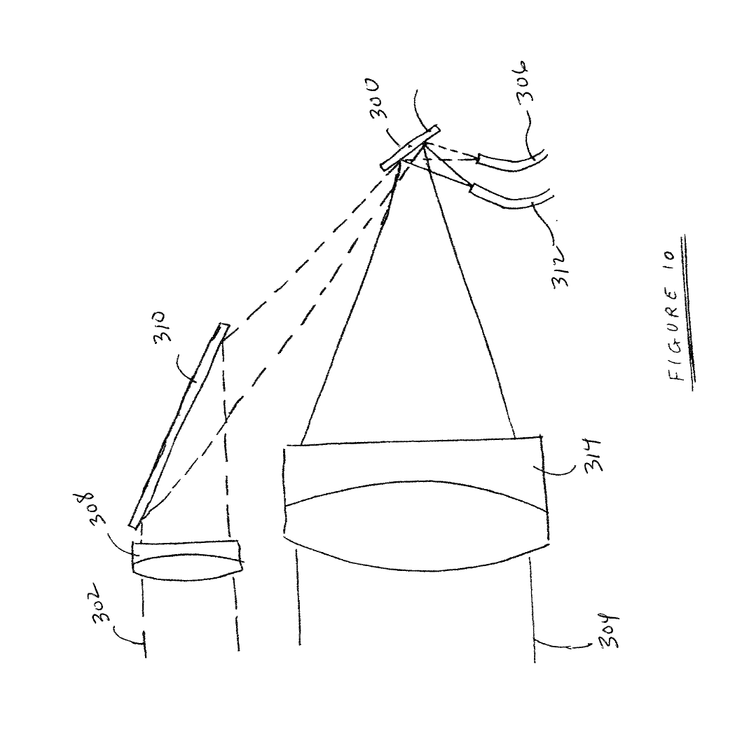

FIG. 10 shows the possible use of one MEMS mirror 300 to control both the transmitted beam 302 and the received beam 304. The transmit fiber 306 is shown having Numerical Aperture (N A) of 0.1, which is common for single mode fibers, and creates an opening of the beam at about 5.7 degrees from the axis. The transmit beam 302 reflects from the MEMS mirror 300 and is aimed at the transmit lens 308 via a fixed mirror 310. The receive fiber 312 is shown having NA of 0.26, which is common for Multi-Mode fibers with core diameter of 62.5 microns. The received beam 304 will have a radius of about 15 degrees. Since it is intended to use the same area of the MEMS mirror 300 for both transmission and reception, the transmit and receive cones can not have parallel axis at the MEMS mirror 300. A fixed receive lens 314 is used, therefore, to make the transmit beam 302 and receive beam 304 parallel outside of this combined beam transmitter and receiver.

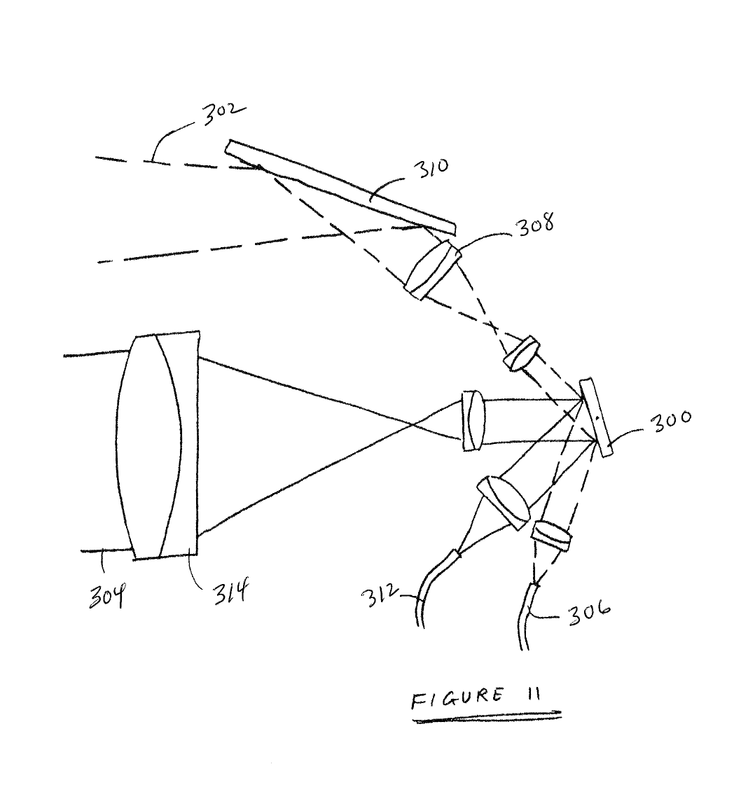

FIG. 11 shows the design of a MEMS mirror 300 serving both transmission and reception, where the transmit beam 302 and receive beam 304 at the MEMS mirror 300 are substantially collimated. The description of each optical path, for transmission and reception, is essentially the same as described for FIG. 4.

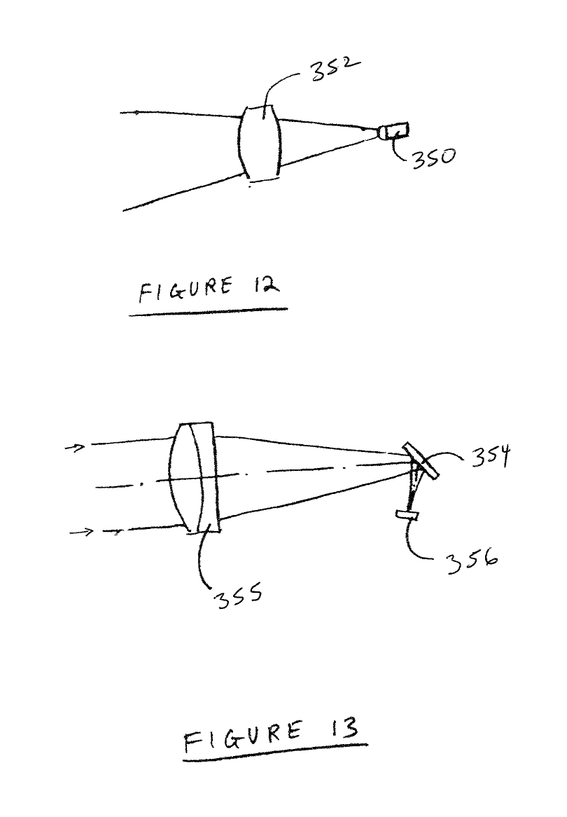

The operation of the atmospheric optical link depends critically on the correct aim of the transmit and receive beams. A servo control must be employed to aim the beams. The servo system should have a different mechanism to align the servo beams, than the data beams, and many different ways are known and described in the prior art. We need, however, a mechanism that makes use of the positioning of the same MEMS mirror as the transmit and receive beams. The essential parts of such a servomechanism are shown in FIGS. 12 and 13. In FIG. 12, a servo LED 350 is used as the light source. A laser could also be used. The servo LED 350 emits light modulated at relatively low speed, enabling detection with low received power. The servo LED lens 352 creates a wide cone of light from the light emitted by the servo LED 350. This cone may be several degrees wide, so the aiming is very simple and the amount of detected radiation is not sensitive to small movements of this beam. FIG. 13 shows the servo sensor, which uses the same MEMS mirror 354 as described before. The light beam in the sensor passes through a servo sensor lens 355 to an optical position detector 356, which is a common art and includes a silicone diode with several outputs. The electrical signals outputted from the position detector 356 are sensitive to the intensity of the optical signal and to the exact location of the optical signal on the position detector 356. The electrical signals indicate if the MEMS mirror 354 is aiming the servo sensor beam directly at the opposing servo LED 350. If there is an error in aiming, the electrical signal outputted from the position detector 356 indicates the direction and magnitude of the error. The servo system will then adjust the MEMS mirror 354 correctly.

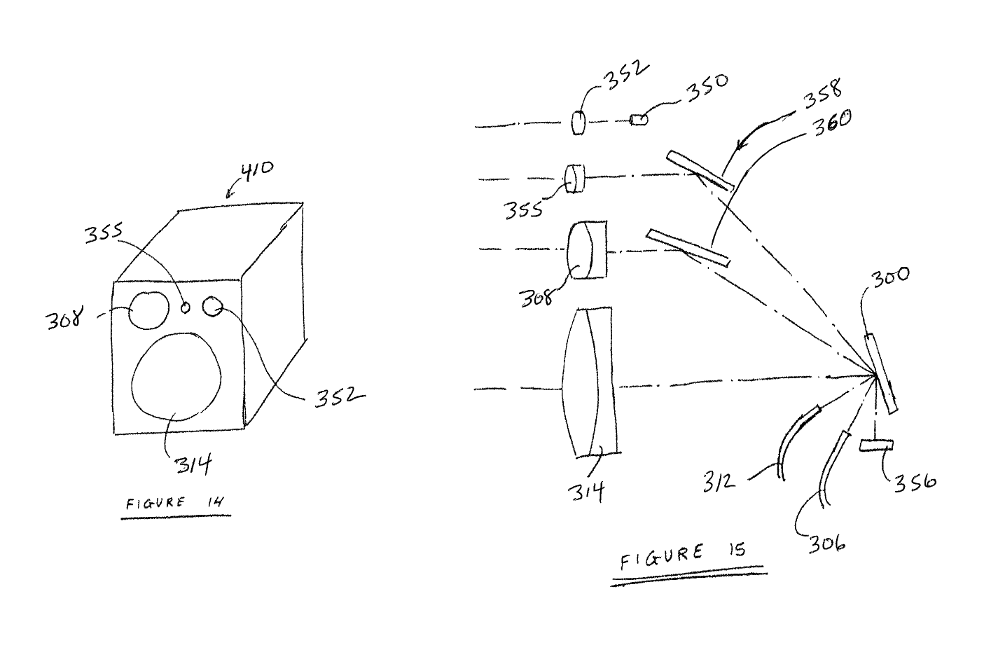

FIG. 14 shows the outside view of the beam transmitter and receiver unit. Four lens, transmit lens 308, receive lens 314, servo sensor lens 355, and servo LED lens 352, are all mounted on the forward face of the transmitter and receiver enclosure 410. In FIG. 15, a flattened drawing of the optical system of FIG. 14 is shown. The optical beams are shown by the central beam only, for clarity. One MEMS mirror is used to control three beams concurrently. The servo LED 350 sends a servo beam through servo LED lens 352. On the corresponding unit, the servo beam passes through servo sensor lens 355, reflects off folding mirror 358, and reflects off MEMS mirror 300 to position sensor 356. The data signal travels from transmit fiber 306, reflects off MEMS mirror 300, reflects off folding mirror 360, and travels through transmit lens 308. In the corresponding unit, the data signal travels through receive mirror 314, reflects off MEMS mirror 300 to receive fiber 312.

Although described above in terms of the preferred embodiment, the present invention is set forth with particularity in the appended claims. Such modifications and alterations as would be apparent to one of ordinary skill in the art and familiar with the teachings of this application shall be deemed to fall within the spirit and scope of the invention.

I claim:

1. An atmospheric optical data transmission system comprising:
an optical transmitter producing an optical data beam;
an optical receiver receiving said optical data beam;
a MEMS mirror redirecting said optical data beam; and
a control system for moving said MEMS mirror to direct said optical data beam toward said optical receiver.

2. The atmospheric optical data transmission system according to claim 1, wherein said atmospheric optical data transmission system serves a plurality of data networks.

3. The atmospheric optical data transmission system according to claim 2, further comprising a 1×N fiber optic switch for distributing data transmission services among said plurality of data networks.

4. The atmospheric optical data transmission system according to claim 1, further comprising an optical amplifier responsive to changes in signal strength at said optical receiver.

5. The atmospheric optical data transmission system according to claim 1, further comprising optical fiber for providing said optical data beam to said optical transmitter.

6. The atmospheric optical data transmission system according to claim 1, further comprising optical fiber for receiving said optical data beam from said optical receiver.

7. The atmospheric optical data transmission system according to claim 1, further comprising an optical aiming beam redirected by said MEMS mirror to aid in aiming said optical data beam.

8. An atmospheric optical data transmission system comprising:
a first optical transmitter producing a first optical data beam;
a first optical receiver receiving said first optical data beam;
a second optical transmitter associated with said first optical receiver, and producing a second optical data beam;
a second optical receiver associated with said first optical transmitter, and receiving said second optical data beam;
a first MEMS mirror redirecting said first and second optical data beams;
a second MEMS mirror redirecting said first and second optical data beams;
a first control system for moving said first MEMS mirror to direct said first optical data beam toward said first optical receiver; and
a second control system for moving said second MEMS mirror to direct said second optical data beam toward said second optical receiver.

9. The atmospheric optical data transmission system according to claim 8, wherein said atmospheric optical data transmission system serves a plurality of data networks.

10. The atmospheric optical data transmission system according to claim 9, further comprising a plurality of 1×N fiber optical switches for distributing data transmission services among said plurality of data networks.

11. The atmospheric optical data transmission system according to claim 8, further comprising a first optical amplifier responsive to changes in signal strength at said first optical receiver; and a second optical amplifier responsive to changes in signal strength at said second optical receiver.

12. The atmospheric optical data transmission system according to claim 8, further comprising optical fibers for providing said first and second optical data beams to said first and second optical transmitters.

13. The atmospheric optical data transmission system according to claim 8, further comprising optical fibers for receiving said first and second optical data beam from said first and second optical receiver.

14. The atmospheric optical data transmission system according to claim 8, further comprising a first and second optical aiming beam redirected by said first and second MEMS mirrors to aid in aiming said first and second optical data beams.

15. A method of aiming an optical data beam comprising:
transmitting an optical data beam from an optical transmitter;
intercepting said optical data beam with a MEMS mirror to redirect said optical data beam toward an optical receiver;
moving said MEMS mirror to correct for movement of said optical transmitter; and
moving said MEMS mirror to correct for movement of said or optical receiver.

16. The method according to claim 15 further comprising:
using an servo beam intercepted by said MEMS; and
moving said MEMS mirror to correct for movement measured in said servo beam.

17. The method according to claim 15 further comprising:
providing a moveable base for said MEMS mirror;
making course adjustments to said optical data beam with said movable base; and
making fine adjustment to said optical data beam with said MEMS mirror.

18. The method according to claim 15 further comprising:
providing an optical amplifier in said optical transmitter; and
increasing or decreasing the output of said optical amplifier to maintain a constant level at said optical receiver.

19. The method according to claim 15 further comprising:
directing said optical data beam from said optical transmitter to said MEMS mirror by means of an optical fiber.

20. The method according to claim 15 further comprising:
focusing said optical data beam with a lens.
